(19) United States
(12) Patent Application Publication
(10) Pub. No.: US 2015/0235347 A1
(43) Pub. Date: Aug. 20, 2015

(54) DISPLAY TERMINAL AND DISPLAY TERMINAL SYSTEM HAVING THE SAME

(71) Applicant: Panasonic Intellectual Property Management Co., Ltd., Osaka (JP)

(72) Inventors: Toru OIZUMI, Osaka (JP); Takeshi HATAKEYAMA, Osaka (JP)

(21) Appl. No.: 14/623,299

(22) Filed: Feb. 16, 2015

(30) Foreign Application Priority Data
Feb. 17, 2014 (JP) 2014-027175
Oct. 29, 2014 (JP) 2014-220501

(51) Int. Cl. G06T 3/60; G09G 5/00; G09G 5/32; A47C 7/72

(52) U.S. Cl. CPC G06T 3/60; A47C 7/72; G09G 5/003; G09G 5/32; G09G 2340/0492; G09G 2320/08

(57) ABSTRACT

A display terminal according to an exemplary embodiment of the present disclosure includes a display that is mounted in a reclinable seat and displays various kinds of information; a receiver for receiving reclining angle information of the seat; a tilt detector for detecting a tilt of the display; and a switching unit for switching between portrait and landscape view on the display. The switching unit switches between portrait and landscape view of the various kinds of information based on the reclining angle information, received by the receiver, of the seat and the tilt, detected by the tilt detector, of the display, and outputs the various kinds of information to the display.

### BACKGROUND

1. Field

The present disclosure relates to a display terminal that is associated with a seat with a reclining function, such as a passenger seat or a bed, and switches between portrait and landscape view of a display screen and a display terminal system having the display terminal.

2. Description of the Related Art

Unexamined Japanese Patent Publication No. H02-220576 discloses a technique that detects a reclining angle and supplies it to a display device mounted in a seat.

Unexamined Japanese Patent Publication No. 2009-92950 discloses a technique that detects a reclining angle and selects a display device with the highest visibility at the reclining angle.

Unexamined Japanese Patent Publication No. 2004-240878 discloses a technique that detects rotational displacement of a mobile phone and switches between portrait and landscape view.

Unexamined Japanese Patent Publication No. 2012-208819 discloses a technique that detects an attitude of a vehicle and a tilt of a smartphone connected wirelessly, for example, and determines display parameters.

### SUMMARY

A display terminal according to an exemplary embodiment of the present disclosure, which is used with a user lying on a seat with a reclining function, includes a display, a receiver, a tilt detector, and a switching unit. The display displays various kinds of information. The receiver receives reclining angle information of the seat. The tilt detector detects a tilt of the display. The switching unit, which has a function to switch between portrait and landscape view on the display, switches between portrait and landscape view of the various kinds of information on the display, based on the reclining angle information, received by the receiver, of the seat and the tilt, detected by the tilt detector, of the display, and outputs the various kinds of information to the display.

### BRIEF DESCRIPTION OF DRAWINGS

FIG. 1 shows a positional relationship between a display terminal and a seat according to a first exemplary embodiment of the present disclosure;

FIG. 2 shows a definition of coordinate axes of the display terminal according to the first exemplary embodiment;

FIG. 3 is a block diagram showing a configuration of the display terminal and a display terminal system having the same according to the first exemplary embodiment;

FIG. 4 shows a relationship between a reclining angle of the seat and an orientation of a display according to the first exemplary embodiment;

FIG. 5 shows a user of the display terminal according to the first exemplary embodiment lying supine;

FIG. 6 shows coordinate axes of the display terminal when the user of the display terminal according to the first exemplary embodiment lies in a supine position;

FIG. 7 shows a tilt angle of the display terminal when the user of the display terminal according to the first exemplary embodiment lies in the supine position;

FIG. 8 shows the user of the display terminal according to the first exemplary embodiment lying laterally;

FIG. 9 shows coordinate axes of the display terminal when the user of the display terminal according to the first exemplary embodiment lies in a lateral position;

FIG. 10 shows a tilt angle of the display terminal when the user of the display terminal according to the first exemplary embodiment lies in the lateral position;

FIG. 11 shows the user of the display terminal according to the first exemplary embodiment lying prone;

FIG. 12 shows a positional relationship between a display terminal, a seat, and a stationary monitor according to a second exemplary embodiment of the present disclosure;

FIG. 13 is a block diagram showing a configuration of the display terminal according to the second exemplary embodiment; and

FIG. 14 is a block diagram showing a configuration of a display terminal according to a third exemplary embodiment.

### DETAILED DESCRIPTION

Exemplary embodiments will now be described in detail with reference to the drawings. Unnecessary details, however, may be omitted. For example, detailed description of well-known matters and repeated description of substantially the same configuration may be omitted. This is to avoid unnecessary redundancy in the following description and to facilitate understanding by those skilled in the art.

The accompanying drawings and the description below are provided to enable those skilled in the art to have a thorough understanding of the present disclosure, and these are not intended to limit the subject matter defined by the claims.

### First Exemplary Embodiment

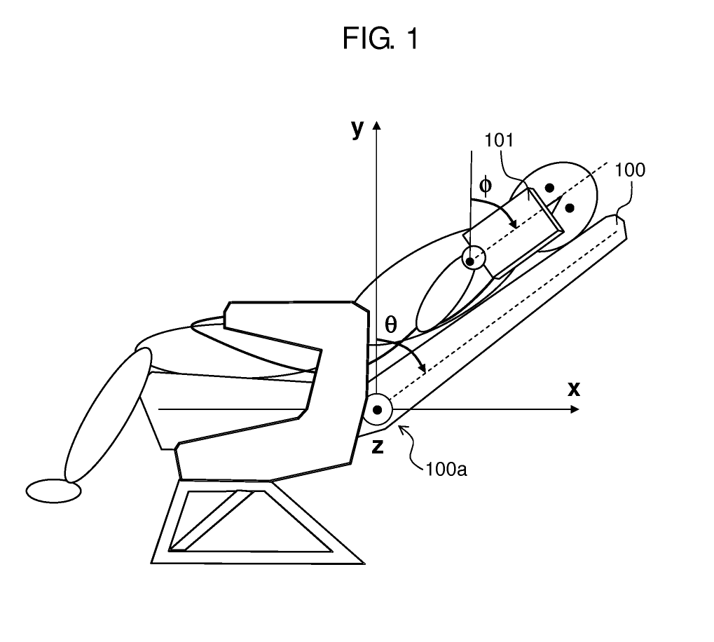

Display terminal 101 and a display terminal system having display terminal 101 according to a first exemplary embodiment are described below with reference to FIGS. 1 to 11.

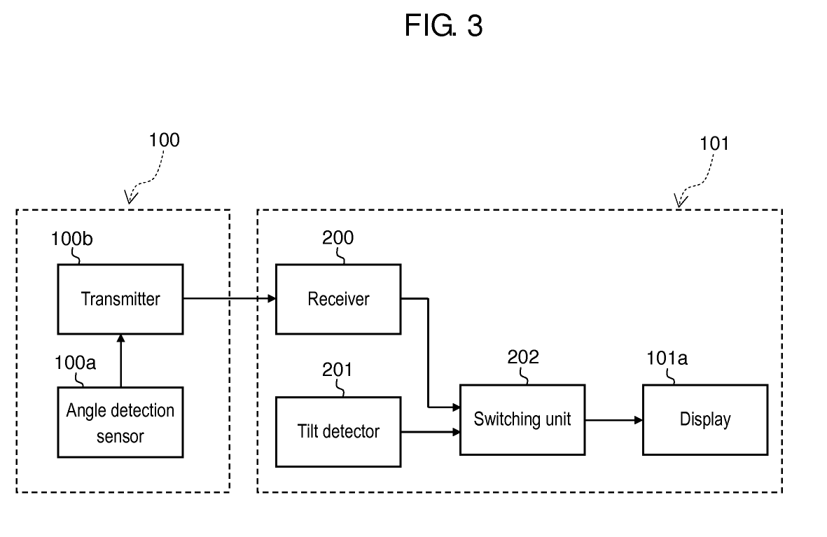

FIG. 1 shows a relationship between seat 100 (a type of seat) and display terminal 101 associated with seat 100. Seat 100 has a built-in transmitter 100b (see FIG. 3) having a transmission function. Seat 100 has a reclining function and transmits reclining angle information to display terminal 101 associated with seat 100.

Here, the reclining function, which is provided in a seat or the like having a backrest portion whose angle can be adjusted, is mainly applied to a seat, bed, etc.

The reclining angle information is obtained by angle detection sensor 100a (see FIGS. 1 and 3) mounted in seat 100 to detect a reclining angle. The reclining angle information obtained is transmitted to display terminal 101 via transmitter 100b mounted in seat 100.

The angle detection sensor for obtaining the reclining angle information of seat 100 can be an acceleration sensor, for example. The acceleration sensor may be mounted near a rotation center of the backrest portion or in the backrest portion of seat 100, for example.

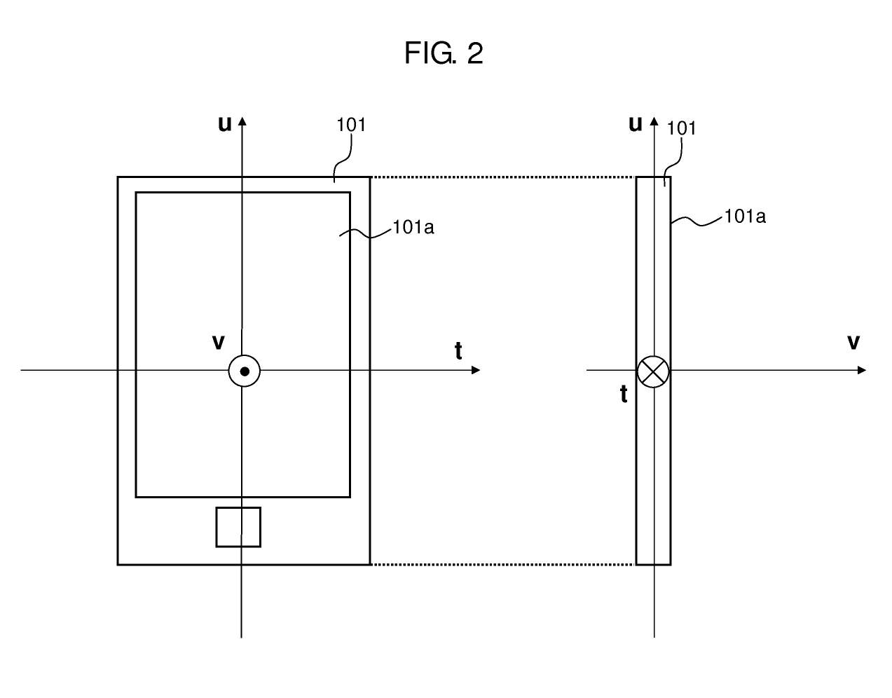

Display terminal 101 has display 101a for displaying various kinds of information (content) as shown in FIG. 2. Display terminal 101 switches between portrait and landscape view of the screen on display 101a based on the reclining angle information from seat 100.

Various kinds of information (content) displayed on display 101a includes video information such as movies, TV programs, videos, and games, map information on flight routes, and character information on flight information, for example.

FIG. 2 shows a definition of coordinate axes of display terminal 101.

As shown in FIG. 2, longitudinal and transverse directions of display terminal 101 and a direction opposite to a screen of display terminal 101 are defined as t-axis, u-axis, and v-axis, respectively.

In general, a device, which switches between portrait and landscape view of the content by tilting the screen of a display terminal such as a smartphone, performs control with a hysteresis characteristic.

That is, when display terminal 101 in portrait orientation is rotated by π/2 on a t-u plane to landscape orientation, for example, when rotated by β=π/3, the content displayed on display 101a is switched from portrait to landscape view. When display terminal 101 in landscape orientation is rotated by −π/2 on the t-u plane to portrait orientation, for example, when rotated by −β=−π/3, the content displayed on display 101a is switched from landscape to portrait view.

An orientation of a user's face is inclined more than β=π/3 in display terminal 101 of the present exemplary embodiment when a reclining angle θ of seat 100 is greater than β=π/3 and the user lies in a lateral position (lies on his or her side) on seat 100. Accordingly, display terminal 101 held by the user is also tilted more than β=π/3 on the t-u plane (i.e., angle φ>β).

### [1-1 Configuration of Display Terminal 101]

FIG. 3 is a block diagram showing a configuration of display terminal 101 and the display terminal system having display terminal 101 according to the present exemplary embodiment.

Display terminal 101 includes display 101a, receiver 200, tilt detector 201, and switching unit 202.

Display 101a displays the various kinds of information (content) from switching unit 202.

Receiver 200 receives the reclining angle information of seat 100 from transmitter 100b mounted in seat 100 and outputs it to switching unit 202.

Tilt detector 201 detects a tilt of display terminal 101 (display 101a) and outputs tilt information detected of display terminal 101 to switching unit 202.

Switching unit 202 determines whether to change an orientation of the display of display terminal 101 based on the reclining angle information of seat 100 input from receiver 200 and the tilt information of display terminal 101 input from tilt detector 201. Specifically, switching unit 202 determines whether to change an orientation of the content displayed on display 101a of display terminal 101 from portrait to landscape, to change the orientation from landscape to portrait, or not to change the orientation. If desired, switching unit 202 switches between portrait and landscape view on display terminal 101 based on a determined result and outputs the content to display 101a.

### [1-2 Detailed Operation of Display Terminal 101]

The present exemplary embodiment focuses on a case where a reclining angle θ of seat 100 is greater than a switching angle between portrait and landscape view of the content.

The present exemplary embodiment is described below assuming β=π/3, where β is an angle at which the portrait and landscape view of the content is switched on the t-u plane. In view of practical use, the reclining angle θ of seat 100 is usually less than or equal to π/2. From the above, the present exemplary embodiment is described in terms of a range of β≦θ≦π/2.

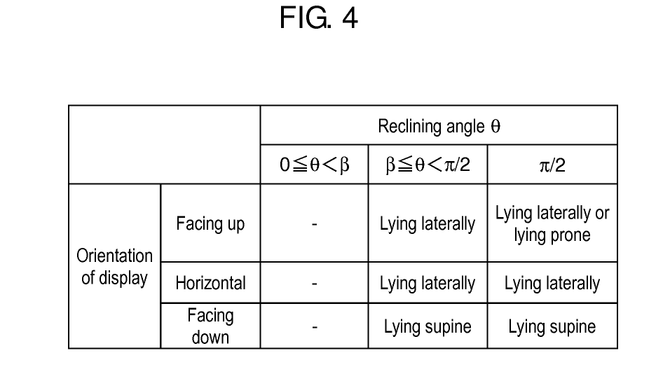

FIG. 4 shows an example of a pose of the user who uses display terminal 101 while lying on seat 100, which pose is estimated based on the reclining angle θ of seat 100 and an orientation of display 101a of display terminal 101 associated with seat 100.

That is, the relationship between the reclining angle θ and an orientation of display 101a of display terminal 101 is classified into three cases: the user lies “in a supine position”, “in a lateral position (lying on his or her side)”, or “either in a lateral position or in a prone position”.

Hereinafter, detailed operation of display terminal 101 is described in three cases: a case where the user lies in the supine position, a case where the user lies in the lateral position, and the other case where the user lies in the lateral position or in the prone position.

[1-2-1 Case when User Lies in Supine Position]

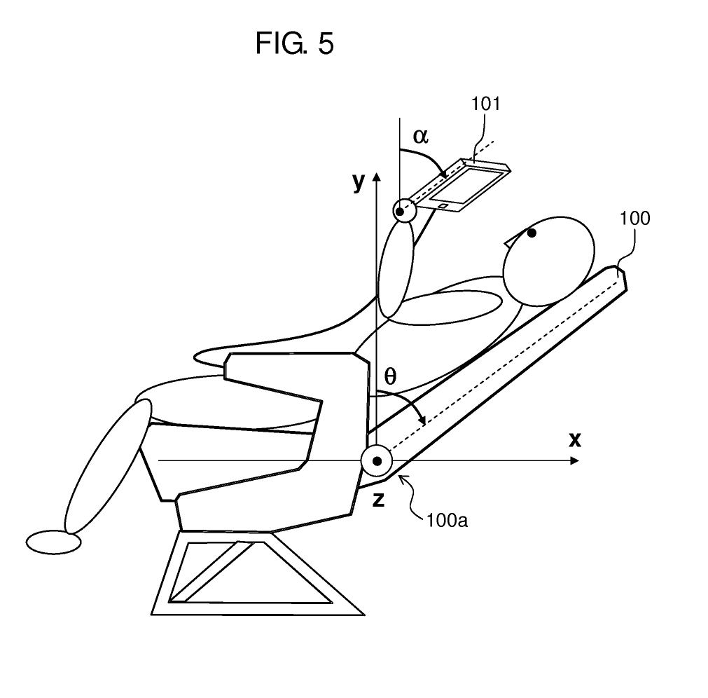

FIG. 5 shows a state in which a user lying on seat 100 reclined at an angle θ (where β≦θ≦π/2) lies in a supine position and uses display terminal 101 while tilting display terminal 101 forward at an angle α (where 0<α), i.e., with the screen of display terminal 101 facing down.

In display terminal 101, receiver 200 receives reclining angle information (i.e., θ) from transmitter 100b mounted in seat 100 and outputs it to switching unit 202.

Tilt detector 201 detects a tilt of display terminal 101. Specifically, tilt detector 201 detects a direction of gravitational acceleration g and the gravitational acceleration g is divided into a gravitational acceleration component g_tu on the t-u plane and a gravitational acceleration component g_v on the v-axis.

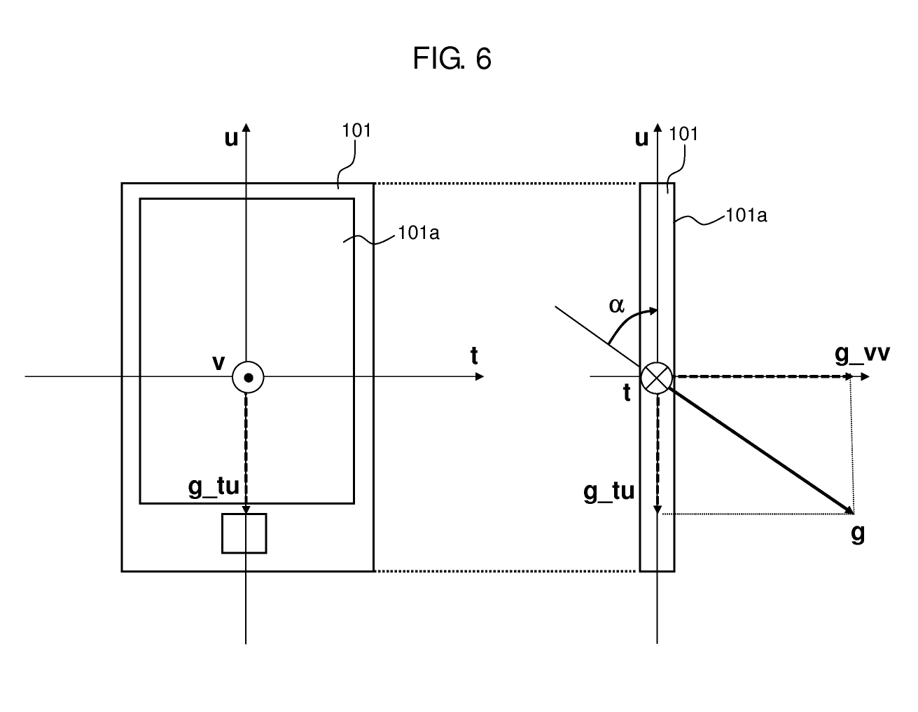

Corresponding to FIG. 5, FIG. 6 shows the gravitational acceleration component g_tu on the t-u plane and the gravitational acceleration component g_v on the v-axis.

Here, the gravitational acceleration component g_tu on the t-u plane is oriented in a negative direction of the u-axis due to no tilt on the t-u plane of display terminal 101. The gravitational acceleration component g_v on the v-axis is oriented in a positive direction since the screen of display terminal 101 is directed downward below a horizontal plane.

Tilt detector 201 outputs, to switching unit 202, the gravitational acceleration component g_tu on the t-u plane and the gravitational acceleration component g_v on the v-axis, which have been calculated by tilt detector 201.

Switching unit 202 interprets that the screen of display terminal 101 is directed downward below the horizontal plane if the reclining angle θ from receiver 200 is in the range of β≦θ≦π/2 and the gravitational acceleration component g_v on the v-axis from tilt detector 201 is positive. In this case, it is therefore estimated that the user lying on seat 100 lies in the supine position and uses display terminal 101.

When the user uses display terminal 101 in portrait mode while holding it with an operation button down, switching unit 202 performs the following display control.

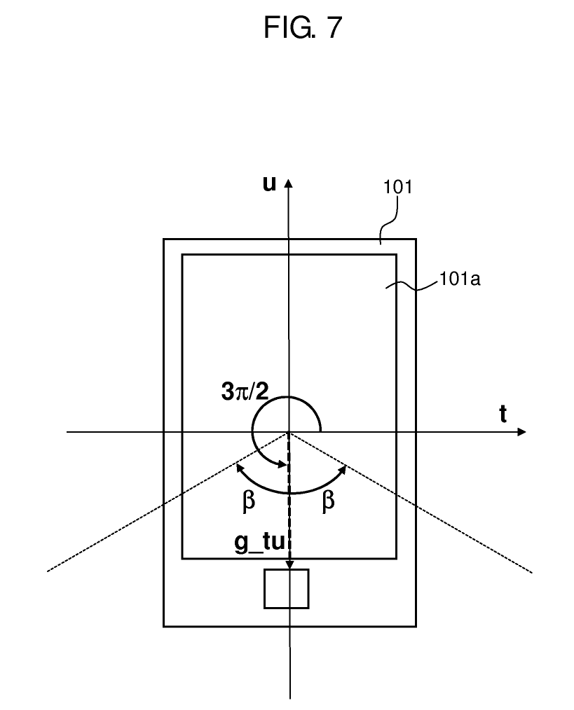

That is, as shown in FIG. 7, if an angle of the gravitational acceleration component g_tu on the t-u plane to the t-axis is reduced from 3π/2 and is below 3π/2−β or if the angle of the gravitational acceleration component g_tu on the t-u plane is increased from 3π/2 and is above 3π/2+β, switching unit 202 outputs the content in landscape mode.

When the user uses display terminal 101 while holding it vertically and upside down with the operation button up, switching unit 202 performs the following display control.

That is, assuming that the angle of the gravitational acceleration component g_tu on the t-u plane to the t-axis is π/2, if the angle of the gravitational acceleration component g_tu on the t-u plane is reduced from π/2 and is below π/2−β or if the angle of the gravitational acceleration component g_tu on the t-u plane is increased from π/2 and is above π/2+β, switching unit 202 outputs the content in landscape mode.

When the user uses display terminal 101 while holding it horizontally at a rightward tilt of 90 degrees with the operation button on the right, switching unit 202 performs the following display control.

That is, assuming that the angle of the gravitational acceleration component g_tu on the t-u plane to the t-axis is zero, if the angle of the gravitational acceleration component g_tu on the t-u plane is reduced from zero and is below −β or if the angle of the gravitational acceleration component g_tu on the t-u plane is increased from zero and is above β, switching unit 202 outputs the content in portrait mode.

When the user uses display terminal 101 while holding it horizontally at a leftward tilt of 90 degrees with the operation button on the left, switching unit 202 performs the following display control.

That is, assuming that the angle of the gravitational acceleration component g_tu on the t-u plane to the t-axis is π, if the angle of the gravitational acceleration component g_tu on the t-u plane is reduced from π and is below π−β or if the angle of the gravitational acceleration component g_tu on the t-u plane is increased from π and is above π+β, switching unit 202 outputs the content in portrait mode.

Thus, the display control is performed based on angle information received by switching unit 202, i.e., a value of the reclining angle θ and an angle of display terminal 101 so that the content on display 101a is displayed in portrait or landscape mode.

[1-2-2 Case when User Lies in Lateral Position]

A display control when a user lies in a lateral position will now be described, where description on parts identical with those of the above-mentioned case when the user lies in the supine position is omitted.

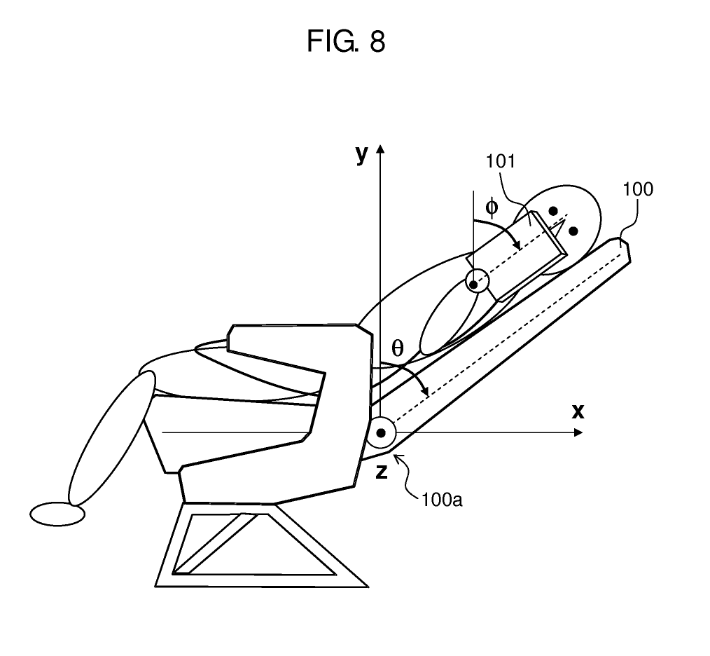

FIG. 8 shows a user who lies on his or her side on seat 100 reclined at an angle θ (where β≦θ≦π/2) and uses display terminal 101 while tilting display terminal 101 sideways at an angle φ.

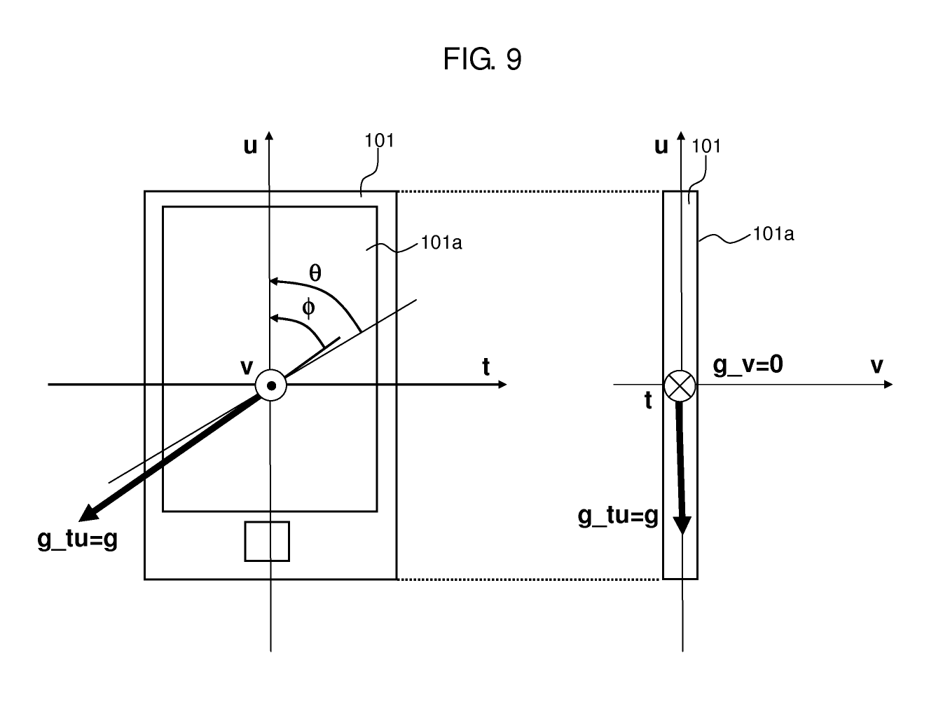

Corresponding to FIG. 8, FIG. 9 shows a gravitational acceleration component g_tu on the t-u plane and a gravitational acceleration component g_v on the v-axis in tilt detector 201.

As shown in FIG. 9, the gravitational acceleration component g_tu on the t-u plane is equal to the gravitational acceleration g. Since display terminal 101 does not tilt in the v-axis direction, the gravitational acceleration component g_v on the v-axis is zero.

Switching unit 202 interprets that the screen of display terminal 101 is oriented in a horizontal plane if the reclining angle θ from receiver 200 is in the range of β≦θ≦π/2 and the gravitational acceleration component g_v on the v-axis from tilt detector 201 is zero. In this case, it is therefore estimated that the user lies on his or her side on seat 100 and uses display terminal 101.

Switching unit 202 interprets that the screen of display terminal 101 is facing up if the reclining angle θ from receiver 200 is in the range of π/3≦θ<π/2 and the gravitational acceleration component g_v on the v-axis from tilt detector 201 is negative. Also in this case, it is therefore estimated that the user lies on his or her side and uses display terminal 101.

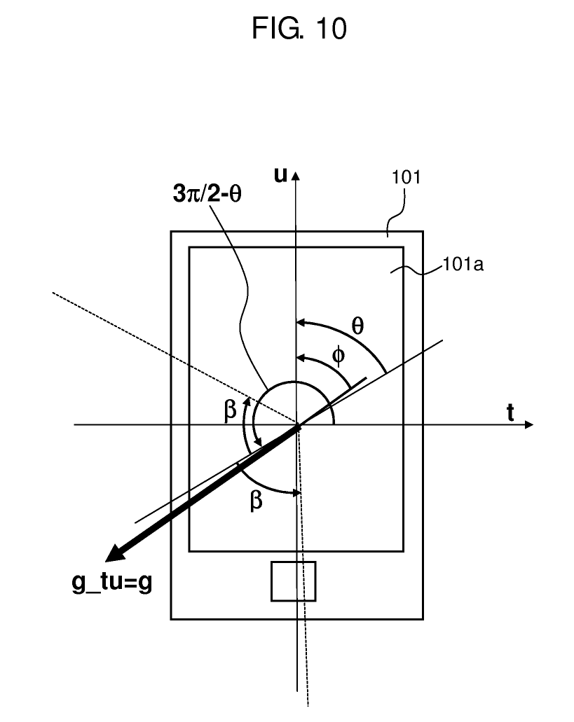

When the user holds and uses display terminal 101 in portrait mode with the operation button being down relative to display 101a, switching unit 202 performs the following display control as shown in FIG. 10.

That is, upon rotation of display terminal 101 (i.e., upon change in a value of φ), if the angle of the gravitational acceleration component g_tu on the t-u plane is reduced from (3π/2−θ) and is below (3π/2−θ)−β or if the angle of the gravitational acceleration component g_tu on the t-u plane is increased from (3π/2−θ) and is above (3π/2−θ)+β, switching unit 202 outputs the content in landscape mode.

When the user uses display terminal 101 while holding it vertically and upside down with the operation button being up relative to display 101a, switching unit 202 performs the following display control.

That is, assuming that the angle of the gravitational acceleration component g_tu on the t-u plane is (π/2−θ), if the angle of the gravitational acceleration component g_tu on the t-u plane is reduced from (π/2−θ) and is below (π/2−θ)−β or if the angle of the gravitational acceleration component g_tu on the t-u plane is increased from (π/2−θ) and is above (π/2−θ)+β, switching unit 202 outputs the content in landscape mode.

When the user uses display terminal 101 while holding it horizontally at a rightward tilt of 90 degrees with the operation button on the right relative to display 101a, switching unit 202 performs the following display control.

That is, assuming that the angle of the gravitational acceleration component g_tu on the t-u plane is −θ, if the angle of the gravitational acceleration component g_tu on the t-u plane is reduced from −θ and is below −θ−β or if the angle of the gravitational acceleration component g_tu on the t-u plane is increased from θ and is above −θ+β, switching unit 202 outputs the content in portrait mode.

When the user uses display terminal 101 while holding it horizontally at a leftward tilt of 90 degrees with the operation button on the left relative to display 101a, switching unit 202 performs the following display control.

That is, assuming that the angle of the gravitational acceleration component g_tu on the t-u plane is (π−θ), if the angle of the gravitational acceleration component g_tu on the t-u plane is reduced from (π−θ) and is below (π−θ)−β or if the angle of the gravitational acceleration component g_tu on the t-u plane is increased from (π−θ) and is above (π−θ)+β, switching unit 202 outputs the content in portrait mode.

[1-2-3 Other Case when User Lies in Lateral Position or in Prone Position]

In the following, the other case when a user lies in a lateral position or in a prone position will be described.

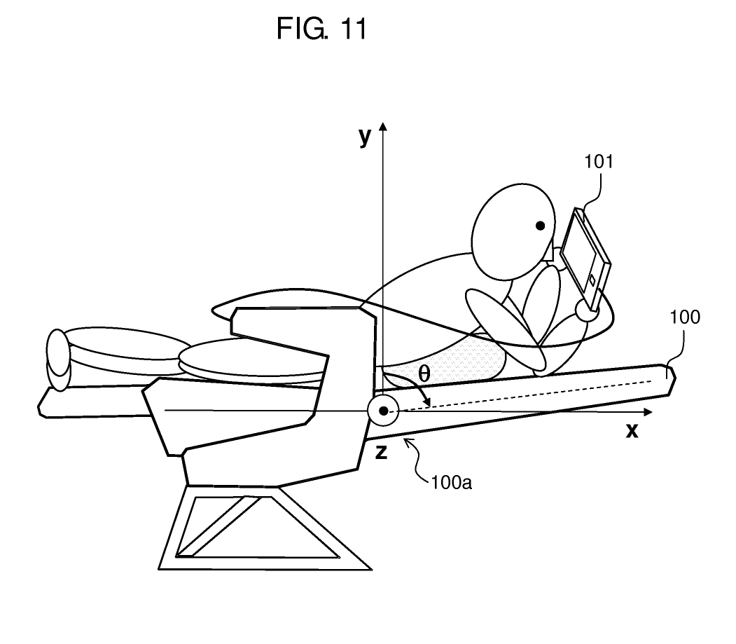

In a case other than the cases described above, a reclining angle θ of seat 100 is π/2 (or very close to π/2), in which the user can lie prone. At this time, if the gravitational acceleration component g_v on the v-axis is positive (i.e., the screen of display terminal 101 facing up), it cannot be determined whether the user of display terminal 101 lies in the lateral position as shown in FIG. 8 or the user lies in the prone position as shown in FIG. 11.

In such a case, switching unit 202 of display terminal 101 can change an orientation of the display based on an input from the user. The input from the user is made, such as by pressing a button on display terminal 101 or by touching a touch panel.

As described above, according to the present exemplary embodiment, various contents can be displayed so that the orientation of the display corresponds to the orientation of the face of the user lying on the seat if the reclining angle of seat 100 is greater than the switching angle between portrait and landscape view of the content.

Seat 100 may be associated with display terminal 101 by wire or by wireless. A combination of seat 100 and display terminal 101 may be prefixed. Alternatively, seat 100 and display terminal 101 can be associated with each other for each use by pairing such as used in Bluetooth®.

### Second Exemplary Embodiment

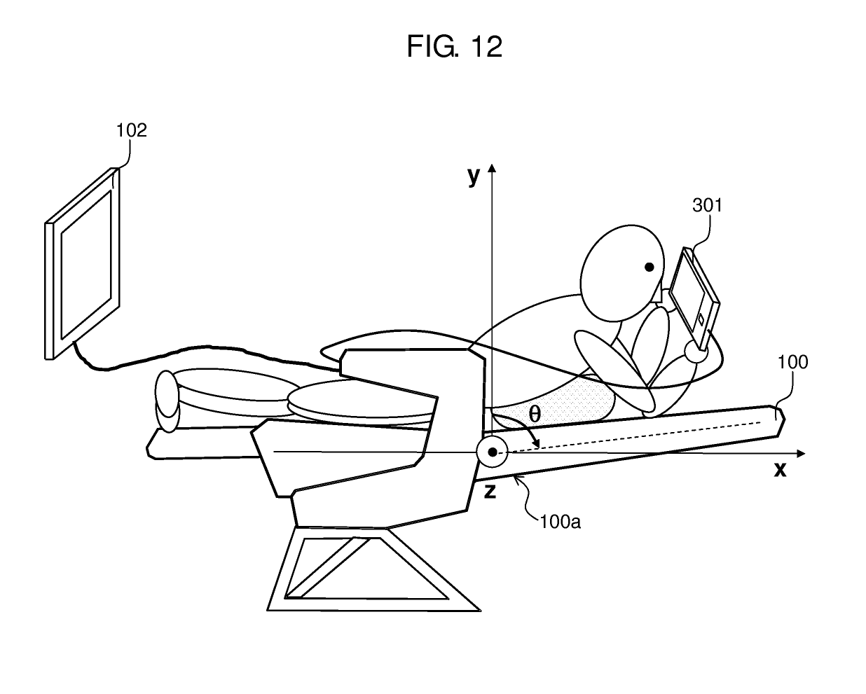

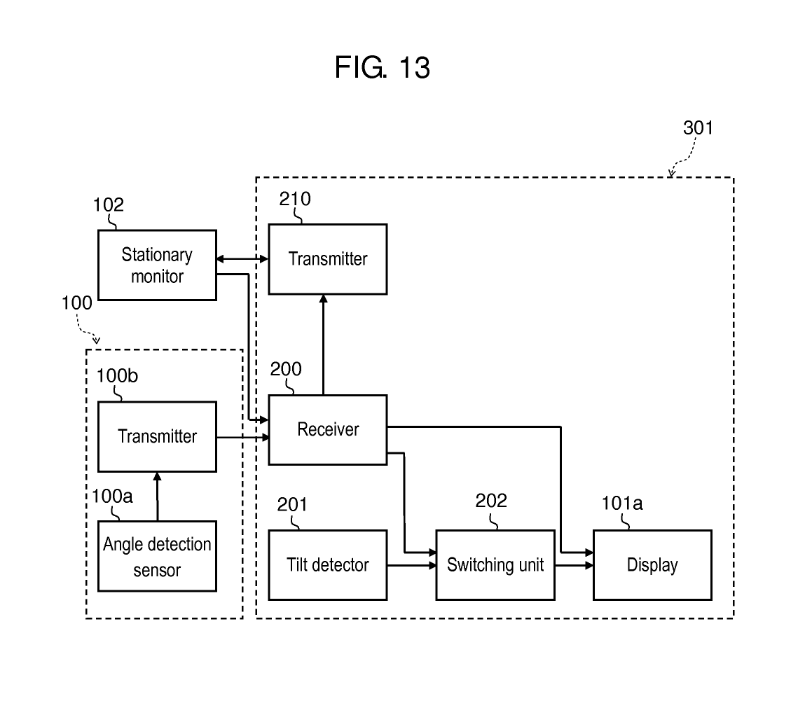

Display terminal 301 and a display terminal system having display terminal 301 according to a second exemplary embodiment of the present disclosure are described below with reference to FIGS. 12 and 13.

For convenience of illustration, components having functions and configurations similar to those described in the first exemplary embodiment are denoted by the same reference numerals and detailed descriptions thereof are omitted.

As shown in FIGS. 12 and 13, the display terminal system including display terminal 301 of the present exemplary embodiment also includes stationary monitor 102 associated with seat 100 or display terminal 301 in addition to display terminal 301 associated with seat 100. An example of such a configuration may be an in-flight entertainment system in an aircraft.

When a reclining angle θ of seat 100 is π/2 or close to π/2 (i.e., seat 100 is substantially flat), display of stationary monitor 102, which has been able to be viewed without any problems in a normal state in which the reclining angle θ is small, may be difficult to see.

In display terminal 301 of the present exemplary embodiment, content displayed on stationary monitor 102 is therefore output to display terminal 301 when the reclining angle θ of seat 100 is π/2 or close to π/2.

This allows a user to view the content such as video of stationary monitor 102 that is difficult to see due to reclined seat 100 using display terminal 301 at hand.

As shown in FIG. 13, display terminal 301 also includes transmitter 210 in addition to the configuration of the first exemplary embodiment.

When the reclining angle θ of seat 100 is π/2 or close to π/2, transmitter 210 sends an instruction to stationary monitor 102 so that the content such as the video displayed on stationary monitor 102 is transmitted to display terminal 301.

Receiver 200 receives the content displayed on stationary monitor 102 and outputs it to display 101a.

Switching unit 202 switches an output destination of the content displayed on stationary monitor 102 to display terminal 301 based on the content displayed on stationary monitor 102 and information indicating portrait and landscape mode input from receiver 200 and outputs the content to display terminal 301.

In display terminal 301 of the present exemplary embodiment, the content of stationary monitor 102 is output to display terminal 301 when the reclining angle θ of seat 100 is π/2 or close to π/2.

Thus, the content, which has been displayed on stationary monitor 102 difficult to see at a large reclining angle, can be viewed on display terminal 301 local to the user.

### Third Exemplary Embodiment

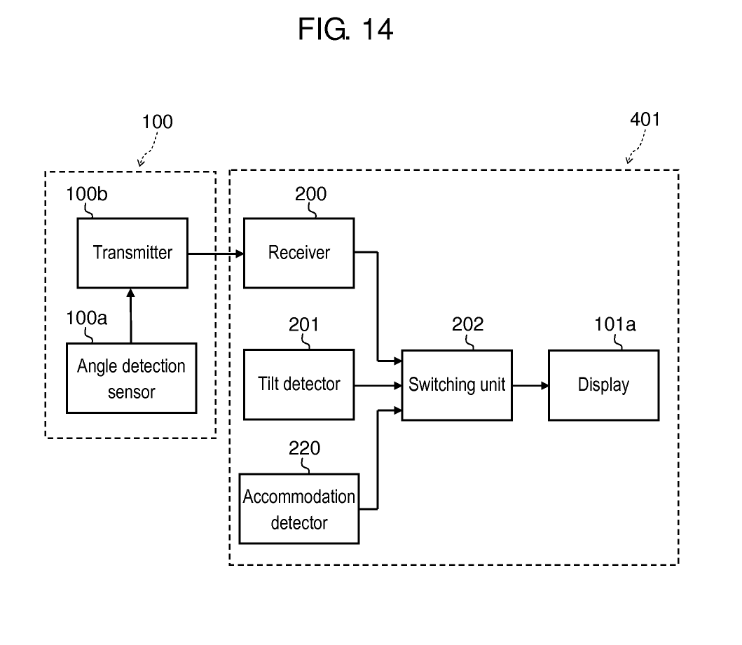

Display terminal 401 and a display terminal system having display terminal 401 according to a third exemplary embodiment of the present disclosure are described below with reference to FIG. 14.

For convenience of illustration, components having functions and configurations similar to those described in the first and second exemplary embodiments are denoted by the same reference numerals and detailed descriptions thereof are omitted.

Display terminal 401 of the present exemplary embodiment, which is received or accommodated in a predetermined accommodating member, includes accommodation detector 220 in addition to the configuration of display terminal 101 described in the first exemplary embodiment, as shown in FIG. 14.

Accommodation detector 220 detects whether display terminal 401 is received in a predetermined accommodating member (i.e., accommodation information about display terminal 401) and outputs it to switching unit 202. The accommodating member for display terminal 401 may be a cradle or a stand, for example.

Switching unit 202 determines the orientation of the display of display terminal 401 based on the accommodation information about display terminal 401 input from accommodation detector 220 in addition to the reclining angle information of seat 100 described above and reclining angle information of display terminal 401.

Specifically, when display terminal 401 is accommodated, for example, content such as video the orientation of which is always fixed in portrait or landscape is sent to display 101a regardless of the reclining angle of seat 100 and tilt information of display terminal 401.

Here, “the orientation of the content is fixed in portrait or landscape” means that the screen is preferably set in portrait mode when display terminal 401 is received vertically in the accommodating member, for example. On the other hand, the screen is preferably set in landscape mode when display terminal 401 is received horizontally in the accommodating member.

For example, if a user cannot view the screen of display 101a of display terminal 401 in an accommodated state using a cradle with a lid, the display 101a of display terminal 401 may be turned off.

In other words, a control can be performed so that the orientation of display 101a of display terminal 401 can not be switched between portrait and landscape mode if the reclining angle of seat 100 is changed.

### Other Exemplary Embodiments

Although the first, second, and third exemplary embodiments of the present disclosure has been described above, the present disclosure is not limited to these exemplary embodiments and various modifications can be made without departing from the spirit and scope of the present disclosure.

### (A)

While an exemplary configuration in which seat 100 is directly connected to display terminal 101 has been described in the exemplary embodiment, the present disclosure is not limited thereto.

For example, a server, to which seat 100 is connected, may obtain the reclining angle information from seat 100, and display terminal 101 connected to the server may obtain the reclining angle information from the server.

That is, seat 100 may be indirectly connected to display terminal 101 via the server etc.

### (B)

While angle detection sensor 100a for detecting the reclining angle of seat 100 and tilt detector 201 for detecting the tilt of display terminal 101 are, for example, acceleration sensors in the exemplary embodiment, the present disclosure is not limited thereto.

For example, tilt detection may be achieved using sensors other than the acceleration sensor or detecting means other than the sensor.

### (C)

In the exemplary embodiment, for convenience of illustration, an example has been described in which the pose of the user is estimated based on whether the gravitational acceleration component g_v on the v-axis is positive, zero, or negative and a method of controlling switching unit 202 is changed; however, the present disclosure is not limited thereto.

For example, the method of controlling switching unit 202 can be changed using certain positive and negative thresholds.

### (D)

Although the orientation of display terminal 101 has been described assuming, for convenience of illustration, that display terminal 101 has the operation button on a lower side of display 101a in the exemplary embodiment, the present disclosure is not limited thereto.

For example, a display terminal may be used that performs all operations using a touch panel on display 101a having no physical operation buttons.

### (E)

When the content of stationary monitor 102 is viewed on display terminal 301 in the second exemplary embodiment, a screen of stationary monitor 102 may be turned off or the same content as that on display terminal 301 may also be displayed on stationary monitor 102.

### (F)

In the second exemplary embodiment, an example has been described in which display terminal 301 receives the reclining angle θ and executes an instruction to send the content of stationary monitor 102; however the present disclosure is not limited thereto.

For example, in an another configuration, stationary monitor 102 may receive the reclining angle θ and may give an instruction to display terminal 301 to display the content displayed on stationary monitor 102.

### (G)

While an exemplary configuration in which display terminal 301 is directly connected to stationary monitor 102 has been described in the second exemplary embodiment, the present disclosure is not limited thereto.

For example, in a configuration in which stationary monitor 102 is connected to a server, display terminal 301 can give an instruction to the server so that the content displayed on stationary monitor 102 is sent to display terminal 301.

### (H)

In the exemplary embodiment, an example has been described in which display terminal 101 uses the tilt itself of display terminal 101 detected by tilt detector 201; however the present disclosure is not limited thereto.

For example, upon application in an aircraft, a tilt of display terminal 101 corrected based on an acceleration of the aircraft may be used.

### (I)

In the exemplary embodiment, an example has been described in which display terminal 101 uses the reclining angle information itself from transmitter 100b mounted in seat 100; however, the present disclosure is not limited thereto.

For example, upon application in an aircraft, a reclining angle of seat 100 corrected based on an angle of attack of the aircraft may be used.

Upon application in a traveling vehicle such as an aircraft and an automobile, the reclining angle information of seat 100 may be corrected by receiving flight angle information of the aircraft or vehicle angle information of the automobile.

### (J)

In the exemplary embodiment, an example has been described in which display terminal 101 receives the reclining angle information from transmitter 100b of seat 100 and controls the orientation of the display; however, the present disclosure is not limited thereto.

For example, if a display terminal itself has the reclining angle information of a seat already, the display terminal needs to obtain no reclining information externally.

This is because if a system that adjusts the reclining angle of a seat, bed, etc. using the display terminal is built, for example, the display terminal has the reclining angle information already.

### (K)

In the exemplary embodiment, an example has been described in which content of the present disclosure is applied to the display terminal or the like included in an in-flight entertainment system in an aircraft; however, the present disclosure is not limited thereto.

For example, the content of the present disclosure is also applied to a display terminal that is used on a reclinable seat installed in traveling means such as a car, bus, bullet train, electric train (including a sleeper, etc.) and in facilities such as a movie theater, hall.

The present disclosure is also applied to a controller (display terminal) mounted in a relax chair or a massage chair that can be seated in a relaxed pose.

A seat with a reclining function includes a bed with a pivotable backrest portion to be inclined as well as the seat described above. The display terminal of the present disclosure is also applied to a display terminal for use on a bed with a reclining function accordingly.

In other words, the exemplary embodiment focuses on the “seat” on which a user is lying. However, the scope of the present disclosure is not limited to a system including the “seat (such as a passenger seat and bed.)”.

For example, the present disclosure can be widely applied to display terminals associated with equipment, devices, etc. on which a user can lie in a supine position and in a lateral position and a tilt of a portion of which can be changed on which portion a user leans, such as a massage chair and a bed with a reclining function.

### (L)

In the exemplary embodiment, an example has been described in which the content of the present disclosure may be implemented as hardware; however, the present disclosure is not limited thereto. For example, the content of the present disclosure can also be implemented as software operating in conjunction with hardware.

### (M)

In the exemplary embodiment, an example has been described in which functional blocks constituting display terminal 101 are typically implemented as integrated circuits or LSIs; however, the present disclosure is not limited thereto.

For example, the functional blocks may be implemented in discrete chips or in a single chip including part or all thereof.

While the LSI is referred to herein as the integrated circuit, it may be referred to as an IC, a system LSI, a super LSI or an ultra LSI depending on the degree of integration.

A method of integrating a circuit is not limited to the LSI, and the method may be implemented by a dedicated circuit or a general-purpose processor.

An FPGA (Field Programmable Gate Array) that is programmable after the LSI has been manufactured and a reconfigurable processor that can reconfigure the connection and setting of circuit cells in the LSI also may be used.

Furthermore, if an integrated circuit technology is available that uses an advanced semiconductor technology or a different technology derived therefrom instead of the LSI, the function blocks may also be integrated using the technology. In this case a biotechnology also can be used, for example.

The display terminal of the present disclosure is useful as a display device associated with equipment, a device, etc. having a seat on which a user can lie in a supine position and in a lateral position and a tilt of a portion of which can be changed on which portion a user leans.

What is claimed is:

1. A display terminal that is used on a seat with a reclining function, the display terminal comprising:
a display for displaying various kinds of information;
a receiver for receiving reclining angle information of the seat;
a tilt detector for detecting a tilt of the display; and
a switching unit which has a function to switch between a portrait view and a landscape view on the display, switches between a portrait view and a landscape view of the various kinds of information on the display based on the reclining angle information, received by the receiver, of the seat and the tilt, detected by the tilt detector, of the display, and outputs the various kinds of information to the display.

2. The display terminal according to claim 1,
wherein the receiver receives the reclining angle information from a transmitter mounted in the seat.

3. The display terminal according to claim 1,
wherein the receiver receives the reclining angle information from an external device connected to the seat.

4. The display terminal according to claim 1,
wherein when the reclining angle information exceeds a predetermined threshold, the switching unit switches between the portrait view and the landscape view of the various kinds of information based on the reclining angle information, and outputs the various kinds of information.

5. The display terminal according to claim 1, further comprising an accommodation detector for detecting whether the display terminal is accommodated in a predetermined position,
wherein when the accommodation detector detects that the display terminal is accommodated, the switching unit keeps a direction of displaying the various kinds of information in either the portrait view or the landscape view regardless of the reclining angle information and the tilt of the display.

6. A display terminal system comprising:
the display terminal according to claim 1;
an angle detector for detecting a reclining angle of the seat; and
a transmitter for transmitting reclining angle information detected by the angle detector to the receiver of the display terminal.

7. A display terminal system comprising:
the display terminal according to claim 1;
a display device associated with the seat; and
a transmitter for sending an instruction to the display device to display, on the display terminal, various kinds of information displayed on the display device when the reclining angle information exceeds a predetermined threshold.
